(19) United States
(12) Patent Application Publication
(10) Pub. No.: US 2006/0256243 A1
(43) Pub. Date: Nov. 16, 2006

(54) Electronic album with television reception functions

(76) Inventors: Ziming Shen, Shanghai (CN); Zhiyong Tang, Shanghai (CN); Hongwei Zhu, Shanghai (CN)

Correspondence Address: CONNOLLY BOVE LODGE & HUTZ, LLP, P O BOX 2207, WILMINGTON, DE, 19899, US

(21) Appl. No.: 10/567,481

(22) PCT Filed: Sep. 19, 2003
(86) PCT No.: PCT/CN03/00798

§ 371 Date: Apr. 10, 2006

(30) Foreign Application Priority Data
Aug. 4, 2003 (CN) 03142038.9

(51) Int. Cl. H04N 5/46

(52) U.S. Cl. 348/729

(57) ABSTRACT

The present invention has disclosed an electronic image frame having the function of TV receiving comprising A/D conversion unit, video decoding unit, signal processing unit, display unit, TV signal tuning unit, multimedia player processing unit, audio processing unit, and microprocessor. The TV RF signal receiving and the playing back of multimedia information in the present electronic image frame have utilized the function units: A/D conversion, video frequency decoding, signal processing, microprocessor, and display and audio processing, which is not only a complete TV set with all the TV receiving functions and common interfaces, such as AV interface, S-VIDEO interface etc., but also can realize the function of an electronic image frame, including: playing picture, music, video files; playing background music while a picture is on show; rotating, amplifying, and automatic displaying; having flexibility for various picture formats and audio and video modes with enhanced functions and practicability.

### TECHNICAL FIELD

The invention relates to an apparatus for displaying images and other information, more specially to an electronic image frame having the function of TV receiver.

### BACKGROUND ART

Along with the fast developments in electronic technology, electronic image frame has become familiar to consumers. The earlier general image frame is made of ordinary frame mounted in with photograph liked with a musical background and even flashing lights decoration by means of some electronic design, which belongs to low-grade goods and is cheap. Then comes a small sized electronic image frame made of liquid crystal screen supporting only picture for displaying color picture or image simply as a desk decoration. These two kinds of electronic image frames all cannot playback audio files, such as MP3 or WMA, except some simple electronic music, and it is out of question for them to playback multimedia files or to carry out functions like temporary storing, amplifying, or rotating images or supporting memory card. Later there appears an image player for VCD or DVD etc. that is to be connected to a television (TV) set by some means for displaying images on the TV set, however, with low resolution, relatively high price, and extreme inconvenience. Most of these image player products cannot playback MP3 or WMA files or other multimedia files or images, except the few relatively advanced ones among them that support playing MP3 or WMA files, they cannot play pictures with background music, and still they do not have the function of playing images in JPEG format commonly used in digital cameras. And the image players can support only a few kinds of memory cards, i.e. only SM card and CF card are supported.

The two electronic image frames and the image player said above all do not have the functions of a TV set, they cannot receive and show television programs independently.

It can be seen from the above descriptions, along with the ever rising living standard and the coming out of various contemporary electronic products, people have more and more reasons to expect the appearance of a new product having the functions of both an electronic frame and a TV set simultaneously.

### SUMMARY OF THE INVENTION

The purpose of the invention is to provide an electronic image frame having the function of TV receiver, i.e. it is designed to possess both the function of an electronic image frame and the function of a TV set.

For the realization of said functions, the technical solution of the invention is as follows:

Said electronic image frame having the function of TV receiver is comprised of an A/D conversion unit, a video signal decoding unit, a signal processing unit, a display unit, a TV signal tuning unit, a multimedia player processing unit, an audio processing unit, and a microprocessor, wherein

The A/D conversion unit receives analog video signal and converts it to digital signal, and sends it into the video signal decoding unit for being processed as video digital signal, which is then sent into the signal processing unit for being processed as image digital signal for displayer, the display unit reduces said image digital signal to image information to complete the video processing;

The TV signal tuning unit receives TV signal in radio frequencies (RF) and processes it as an analog video signal for being sent into the A/D conversion unit and an audio signal for being subsequently power amplified in the audio processing unit and then sent to the loudspeaker to complete the audio processing;

The multimedia player processing unit decodes the multimedia file on the memory card to video signal and audio signal, the video signal is sent into the A/D conversion unit for being converted to digital signal, it is sent into the video signal decoding unit for being processed as video digital signal, which is then sent into the signal processing unit for being processed as image digital signal for displayer, the display unit reduces said image digital signal to image information to complete the video processing; and the audio signal is sent into the audio processing unit for being power amplified and then sent to the loudspeaker to complete the audio processing;

The microprocessor is connected to the A/D conversion unit, the video signal decoding unit, the signal processing unit, the audio processing unit, the multimedia player processing unit, the TV signal tuning unit, respectively, to control them and adjust their parameters via I²C serial bus for dual communication.

### DESCRIPTION OF THE DRAWINGS

FIG. 1 is the principle block diagram for the electronic image frame of the invention.

FIG. 2 is the principle block diagram for the electronic image frame of the invention when it is used as a TV set.

FIG. 3 is the principle block diagram for the electronic image frame of the invention when it is used as a player.

FIG. 4 is the principle block diagram for the electronic image frame of the invention when it is used as multimedia player.

FIG. 5 is the block diagram of control processes of basic parameters of the displayer in the invention.

FIG. 6 is the block diagram of the control processes of TV receiving in the invention.

FIG. 7 is the block diagram of the control processes of the player in the invention.

### THE PREFERRED EMBODIMENTS

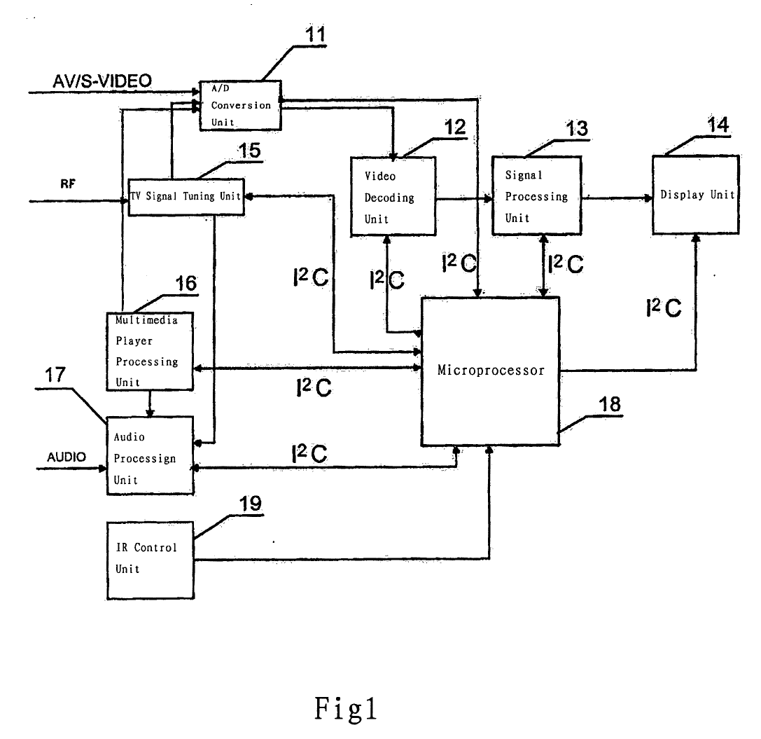

Referring to FIG. 1, the electronic image frame having the function of TV receiver of the present invention is comprised of A/D conversion unit 11, video signal decoding unit 12, signal processing unit 13, display unit 14, TV signal tuning unit 15, multimedia player processing unit 16, audio processing unit 17, and microprocessor 18, wherein

The A/D conversion unit 11 receives analog video signal (VIDEO or S-VIDEO) and converts it to digital signal, and sends it into the video signal decoding unit 12 for being processed as video digital signal, which is then sent into the signal processing unit 13 for being processed as image digital signal for displayer, the display unit 14 reduces said image digital signal to image information to complete the video processing;

The TV signal tuning unit 15 receives TV signal in radio frequencies and processes it as an analog video signal (VIDEO or S-VIDEO) for being sent into the A/D conversion unit 11 and an audio signal, (AUDIO) for being subsequently power amplified in the audio processing unit 17 and then sent to the loudspeaker to complete the audio processing;

The multimedia player processing unit 16 decodes the multimedia file on the memory card to video signal and audio signal, the video signal is sent into the A/D conversion unit 11 for being converted to digital signal, it is sent into the video signal decoding unit 12 for being processed as video digital signal, which is then sent into the signal processing unit 13 for being processed as image digital signal for displayer, the display unit 14 reduces said image digital signal to image information to complete the video processing; and the audio signal is sent into the audio processing unit 17 for being power amplified and then sent to the loudspeaker to complete the audio processing;

The microprocessor 18 is connected to the A/D conversion unit 11, the video signal decoding unit 12, the signal processing unit 13, the audio processing unit 17, the multimedia player processing unit 16, the TV signal tuning unit 15, respectively, to control them and adjust their parameters via I²C serial bus for dual communication.

Said electronic image frame comprising further the IR control unit 19 for receiving infrared control signal and processing it as digital serial signal to be sent into the microprocessor 18, as soon as said signal is received by the microprocessor 18, control instructions shall be transmitted from the microprocessor 18 to the corresponding control terminals of the video signal decoding unit 12, the signal processing unit 13, the audio processing unit 17, the multimedia player processing unit 16, and the TV signal tuning unit 15 for controlling, operating and adjusting various parameters thereof.

The function units in the invention as mentioned above are described more in detail as below.

The A/D Conversion Unit 11:

The A/D conversion unit 11 is mainly for processing video signal. The microprocessor 18 alternatively turns on the A/D conversion unit 11 via I²C serial bus and switches the A/D conversion unit 11 to the channel of VIDEO or S-VIDEO for converting video analog signal to digital signal for the next processing.

The A/D conversion unit 11 can be connected for selective processing through the microprocessor 18 to: the VIDEO or S-VIDEO interfaces of DVD or VCD players, the VIDEO signal end after the TV signal tuning unit 15, the VIDEO or S-VIDEO signal end after the multimedia player processing unit 16, respectively.

The TV Signal Tuning Unit 15:

After the microprocessor 18 alternatively turns on the TV signal tuning unit 15 via I²C serial bus and the system comes into TV receiving operation mode:
1) TV RF signal is received and demodulated by the TV signal tuning unit 15 to TV analog video signal to be sent to the A/D conversion unit 11 and the video decoding unit 12, and audio signal to be sent to the audio processing unit 17;
2) Receiving controlling signal from the microprocessor 18 via I²C serial bus, the TV signal tuning unit 15 operates for selecting and setting TV channels;
3) Supporting the following frequency bands:
   VHF Low band: 48.25-170.00 MHz
   VHF High band: 170.00-450.00 MHz
   UHF band: 450.00-863.25 MHz.

The Video Signal Decoding Unit 12:

The video signal decoding unit 12 processes the digital signal from the A/D conversion unit 11, i.e. decodes it to video digital signal to be then sent into the next signal processing unit 13. The video signal decoding unit 12 supports several digital video mode, such as YUV and RGB.

The Signal Processing Unit 13:

The signal processing unit 13 converts YUV or RGB signal to image digital signal needed for displayer, and adjusts the various parameters of the displayer by means of OSD menu adjustment control via I²C bus.

The Display Unit 14:

The display unit 14 converts said image digital signal from the signal processing unit 13 to image information by using TFT-LCD display module, or using displayer, such as PDP or CRT etc., wherein the mainstream display resolutions are supported, such as 640×480, 800×600, 1024×768, 1280×1024 etc.

The Microprocessor 18:

The microprocessor 18 is the center for information and control, having the principal functions: controlling the selection control and parameter adjustment of the A/D conversion signal source, controlling the channel selection and parameter adjustment of the TV tuning unit 15, the selection control and parameter adjustment of the video decoding unit 12, the control and parameter adjustment of the multimedia player processing unit 16, the control and parameter adjustment of the audio processing unit 17, the control and signal processing of the IR control unit 19, and monitoring the normality of the operations of the whole system, whose parameters are all stored in the electrically erasable memories with convenience for the management and preservation of the parameters, the communications between the microprocessor 18 and the function units as mentioned above are realized by means of the I²C serial bus.

The Audio Processing Unit 17:

The microprocessor 18 controls the parameter adjustments of the audio processing unit 17 and the multimedia player processing unit 16 via the I²C serial bus: the balance of treble and bass tone, the volume, and the other characteristics from audio power amplification to acoustic fidelity.

The IR Control Unit 19:

The IR control unit 19 receives IR signal from a remote controller, and send the corresponding signal to the microprocessor 18, from which control instructions are transmitted to the function units to be controlled.

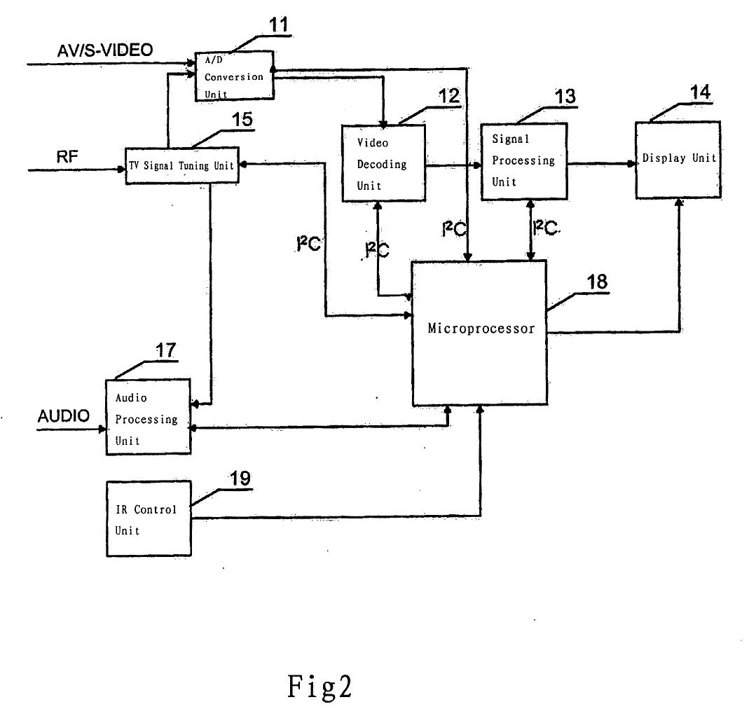

Referring to FIG. 2, wherein the whole system of the invention is switched to the mode of TV receiving when the TV signal tuning unit 15 is turned on, said electronic image frame comes into the operation mode as shown in FIG. 2.

The frequency channel selection information is sent by the user using IR remote controller to the microprocessor 18 for processing and the channel information is sent via I²C serial bus into the TV signal tuning unit 15 for channel selection therein and then demodulation to output divided VIDEO and AUDIO signals, the video signal VIDEO is sent to the A/D conversion unit 11 for being converted to digital signal, which is sent into the video signal decoding unit 12 for being processed as video digital signal, which is then sent into the signal processing unit 13 for being processed as image digital signal for displayer, which is eventually sent into the display unit 14 to be reduced to image information in order to complete the video processing; while the audio signal AUDIO is sent into the audio processing unit 17 for being power amplified and then sent to the loudspeaker to complete the audio processing.

In order to realize functions like sound suppression (silencing), channel reselection, automatic searching etc., control information can all be sent by the user using IR remote controller to the microprocessor 18, after processing therein the corresponding control instructions are conveyed via the I²C serial bus to the relevant units to carry out the needed function.

There are two external interfaces: the VIDEO interface, and the AUDIO interface.

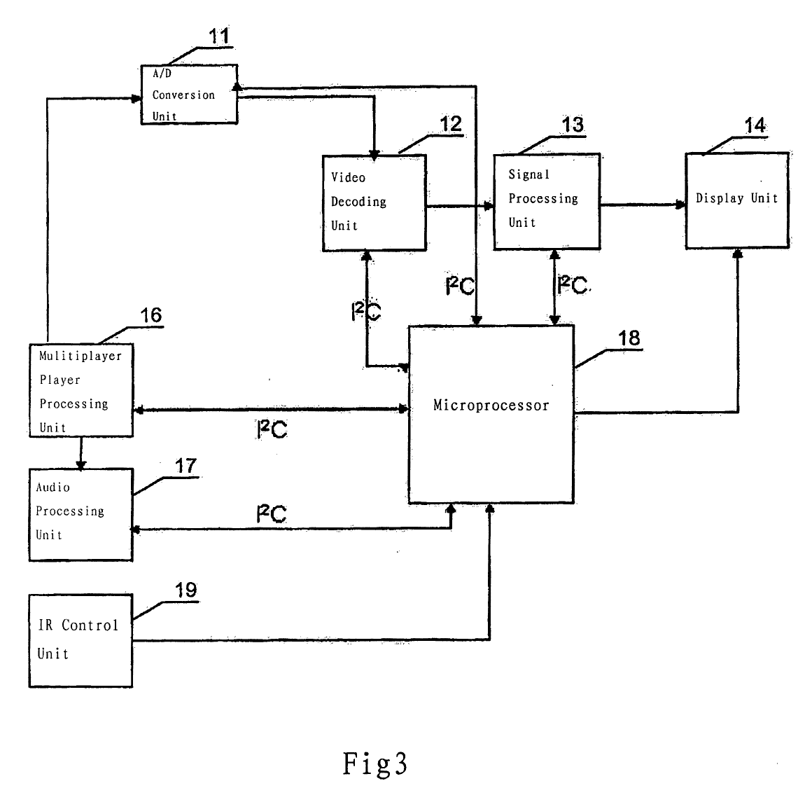

Referring further to FIG. 3, where the system is switched to the operation mode of a player as shown in FIG. 3. When the player mode is turned on, the information on the memory card, if it is there, is first checked, and the multimedia file is decoded according to the user setting or system default to VIDEO or S-VIDEO signal, which is then sent into the A/D conversion unit 11 for being further processed; and the audio signal AUDIO is sent into the audio processing unit 17 for being audio processed. The processing procedures for VIDEO or S-VIDEO signal, and for AUDIO signal are similar to what have been described above.

The player mode can also be controlled remotely, the control information is sent by the user using IR remote controller to the microprocessor 18, after processing therein the corresponding control instructions are conveyed to the multimedia player processing unit 16 to carry out various controlled functions, wherein the data exchange and control are realized by communicating information via the I²C serial bus.

All control information and parameters are stored in the electrically erasable memories for the use of parameters by the system in next time.

As the multimedia processing center, the operation of the multimedia player processing unit 16 is shown in FIG. 4. After the multimedia memory card is inserted into the multimedia player, the memory card driving unit 161 detects information on the card and drives the card to transmit the information contained in the multimedia file thereon to the multimedia processing unit 162 for being decoded and sent into both video processing unit 163 to output VIDEO or S-VIDEO signal and audio output unit 164 to output audio signal.

The buffer storage 165 is used for data buffering to ease the data processing of the multimedia player processing unit 16; the electrically erasable memory 166 stores the various parameters for the player, and the flash storage 167 stores system programs and may be updated.

The control processing unit 168 processes the control signals sent from the microprocessor 18, then transmits the corresponding control information to the multimedia processing unit 162 for performing the various control and parameter adjustment in the multimedia player processing unit 16, while the parameters thereof are stored in the electrically erasable memory 166 for later application.

The functions of the multimedia player processing unit 16 can also be controlled remotely, IR signal is sent by the user using the remote controller to the microprocessor 18 for being processed and then sent to the multimedia processing unit 162 for further processed to adjust the functions of itself, thus to realize the control of the player.

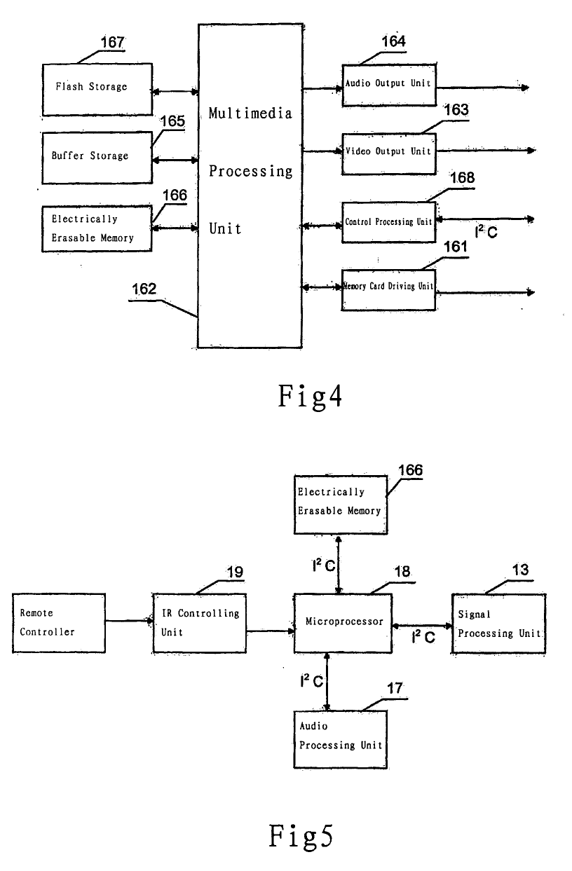

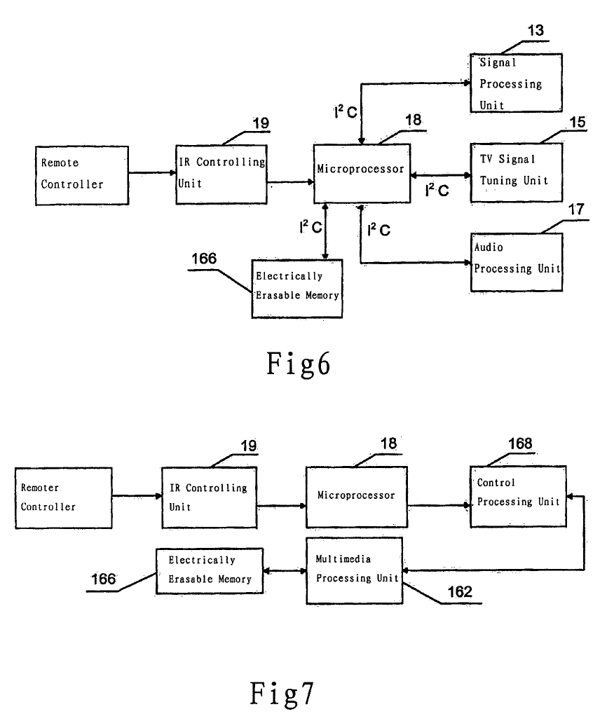

Referring further to FIG. 5, FIG. 6, and FIG. 7, a detailed description for the control processes of the microprocessor to the parameters of the displayer, to the TV receiving, and to the player is given below.

The Control of the Basic Parameters of the Displayer:

The user modifies IR parameters and emits IR signal using the remote controller, the IR control unit receives said signal and transmit it to the microprocessor for processing, and then the adjusted data are sent via I²C bus to the signal processing unit and audio processing unit to change their basic parameters, so as to adjust the parameters of the displayer, e.g. setting up its brightness, contrast, saturation, and sound effects. After the adjustment, the parameters are transmitted via I²C bus to the electrically erasable memory to be stored there for protection and the next application.

The adjustable parameters are:

Brightness Contrast Sharpness Saturation Colority Horizontal level Vertical level OSD closed time OSD transparency Volume Bass Treble Balance Menu language Chinese English.

The Remote Control of the TV Receiving:

This function is mainly for user TV program adjustment and TV parameter setting. The user modifies IR parameters and emits IR signal using the remote controller, the IR control unit receives said signal and transmit it to the microprocessor for processing, and then the data are sent to the TV signal tuning unit, video processing unit and audio processing unit to change their basic parameters, so as to attain the adjusted function of TV receiving, the main parameters to be adjusted are channel selection, automatic frequency correction, sound adjustment, and their fine adjustments.

After the adjustment, the parameters are transmitted via I²C bus to the electrically erasable memory to be stored there for protection and the next application.

The functions which can be realized through IR control are:

TV channel plus and minus, Channel fine adjusting, Channel digital key selection, Silencing, Volume plus and minus, Preset channel, Channel exchange, Automatic frequency correction (AFC), AFC remove.

The Remote Control of the Player:

The user modifies IR parameters and emits IR signal using the remote controller, the IR control unit receives said signal and transmit it to the microprocessor for processing, the data are sent to the control processing unit and then to the multimedia processing unit to carry out the various functions based on user's requirement: if it is player parameter to be adjusted, the pointed parameters are thus set to complete user's needs; if it is system parameter having been modified, it can then be reserved into the electrically erasable memory, where the basic system parameters are kept.

The functions of the player are:

Playing back: MP3 files; WMA files; MPEG1, MPEG2, and MPEG4 files; AVI files;

including Pausing of playing back files, Cycling and Previewing;

Playing JPEG format images or pictures;

Picture Previewing; Picture Amplification ×1, ×3, ×5; Picture Rotating;

Playing background music while favored static picture or image is displayed, or while slides are on show;

Slides showing, slides display mode setting: 13 modes;

including Pausing of playing back files as the occasion demands, Cycling function;

The multimedia memory cards supported are: SM, SD, MS, MS PRO, MMC; CF, and IBM MICRODRIVE commonly used memory cards;

Displayer candidate types: CRT, PDP, TFT-LCD, etc.

### INDUSTRIAL APPLICABILITY

The electronic image frame having function of TV receiving in the present invention comprising A/D conversion unit, video decoding unit, signal processing unit, display unit, TV signal tuning unit, multimedia player processing unit, audio-processing unit, microprocessor. The TV RF signal receiving and the playing back of multimedia information in the present electronic image frame have utilized the function units: A/D conversion, video frequency decoding, signal processing, display and audio processing, which is not only a complete TV set with all the TV receiving functions and common interfaces, such as AV interface, S-VIDEO interface etc., but also can realize the function of an electronic image frame, such as: playing picture, music, video files; playing background music while a picture is on show; rotating, amplifying, and automatic displaying; having flexibility for various picture formats and audio and video modes with enhanced functions and practicability.

The product has various functions, in addition to the functions of TV receiver and multimedia player, video and audio interfaces have been prepared for easy connection to commonly used DVD, VCD or other playing back facilities with the corresponding interfaces. The system is comprised of 9 main modules to be selectively connected by the user through the control and communication of the microprocessor via I²C serial bus to attain the various functions.

1-3. (canceled)

4. An electronic image frame, comprising:
a tuning unit for receiving television signal and dividing said television signal into first analog video signal and first audio signal;
a multimedia player processing unit for decoding multimedia files into second analog video signal and second audio signal;
a video processing unit for converting said first and second analog video signal into digital video signal;
a display unit for displaying said digital video signal;
an audio processing unit for amplifying said first and second audio signals; and
a microprocessor coupled to said tuning unit, said multimedia player processing unit, said video processing unit, said display unit and audio processing unit, and for controling operations thereof with control signals.

5. The electronic image frame according to claim 4, said multimedia player processing unit comprising:
a memory card driving unit for transmitting said multimedia files to said multimedia processing unit;
a multimedia processing unit for decoding multimedia files into said second analog video signal and said second audio signal;
an audio outputting unit for outputting said second audio signal;
a video outputting unit for outputting said second video signal; and
a control processing unit coupled to said microprocessor and for controlling said multimedia processing unit in reponse to said control signals. F

6. The electronic image frame according to claim 5, said multimedia player processing unit further comprising:
a flash storage for storing program executed by said control processing unit;
a buffer storage for temporarily storing data generated during operation of said multimedia player processing unit; and
an electrically erasable memory for storing parameters for operation of said multimedia player processing unit.

7. The electronic image frame according to claim 4, said video processing unit comprise an A/D conversion unit for converting said analog video signal into digital signal, a video signal decoding unit for decoding said digital signal, and a signal processing unit for tranforming said decoded digital signal into digital video signal and sending digital video signal to said display unit.

8. The electronic image frame according to claim 4, said microprocessor is coupled to said tuning unit, said multimedia player processing unit, said video processing unit, said display unit and audio processing unit via I²C serial bus.

9. The electronic image frame according to claim 4, further comprising an infrared control unit coupled to said microprocessor, for receiving IR controlling signal, converting said IR controlling signal into digital serial signal and sending said digital serial signal to said microprocessor.
